(19) United States
(12) Patent Application Publication
(10) Pub. No.: US 2013/0080222 A1
(43) Pub. Date: Mar. 28, 2013

(54) SYSTEM AND METHOD FOR DELIVERING TARGETED ADVERTISEMENTS BASED ON DEMOGRAPHIC AND SITUATIONAL AWARENESS ATTRIBUTES OF A DIGITAL MEDIA FILE

(71) Applicant: SOOH Media, Inc., Scottsdale, AZ (US)

(72) Inventor: Blake Quinn, Scottsdale, AZ (US)

(73) Assignee: SOOH Media, Inc., Scottsdale, AZ (US)

(21) Appl. No.: 13/623,855

(22) Filed: Sep. 20, 2012

Related U.S. Application Data
(60) Provisional application No. 61/626,372, filed on Sep. 27, 2011.

(51) Int. Cl. G06Q 30/02

(52) U.S. Cl. 705/14.5; 705/14.66; 705/14.58

(57) ABSTRACT

The present disclosure provides a system and method of distributing a targeted advertisement based on demographic and situational awareness attributes. A digital media file can be analyzed for demographic and situational awareness attributes. A targeted advertisement can be selected based on the demographic and situational awareness attributes identified. The advertisement and a representation of the digital media file can be distributed to provided contact information.

### CROSS-REFERENCE TO RELATED APPLICATION

This application claims priority to U.S. provisional patent application 61/626,372, filed Sep. 27, 2011, the entire contents of which are hereby incorporated by reference.

### FIELD OF TECHNOLOGY

The present disclosure relates generally to targeted advertisements and specifically to targeted advertisements based on demographic and situational awareness attributes extracted from a digital media file.

### BRIEF DESCRIPTION OF THE DRAWINGS

In order to describe the manner in which aspects of the disclosure can be implemented, explanations will be rendered with reference to specific examples thereof which are illustrated in the appended drawings. Understanding that the drawings depict only example embodiments of the disclosure and are not therefore to be considered to be limiting of its scope, the principles herein are described and explained with additional specificity and detail through the use of the accompanying drawings in which:

FIG. 1 is a block diagram of a system for delivering targeted advertisements based on demographic and situational awareness attributes of a digital media file, in accordance with an example implementation of the present technology;

FIG. 2 is a flow diagram of a method of delivering targeted advertisements based on demographic and situational awareness attributes of a digital media file in accordance with an example implementation of the present technology;

FIG. 3 is a flow diagram of a method of delivering targeted advertisements based on demographic and situational awareness attributes of a digital media file in accordance with an example implementation of the present technology in accordance with an example implementation of the present technology;

FIG. 4 is a front view of a digital media terminal in accordance with an example implementation of the present technology;

FIG. 5 is a flow chart of a method of delivering targeted advertisements based on demographic and situational awareness attributes of a digital media file in accordance with an example implementation of the present technology;

FIG. 6 is a block diagram of a system for delivering targeted advertisements based on demographic and situational awareness attributes of a digital media file, in accordance with an example implementation of the present technology, illustrating a competition between digital media terminals;

FIG. 7 is a screenshot of a graphical user interface in accordance with an example implementation of the present technology, illustrating an advertiser login screen;

FIG. 8 is a screenshot of a graphical user interface in accordance with an example implementation of the present technology, illustrating an advertiser main page;

FIG. 9 is an example screenshot of a graphical user interface in accordance with an example implementation of the present technology, illustrating an advertiser template selection page;

FIG. 10a is an example screenshot of a graphical user interface in accordance with an example implementation of the present technology, illustrating an example watermarked digital image;

FIG. 10b is an example screenshot of an example watermarked digital image; in accordance with an example implementation of the present technology;

FIG. 11a is an example screenshot of a graphical user interface in accordance with an example implementation of the present technology, illustrating an advertisement layout;

FIG. 11b is an example screenshot of an example advertisement layout in accordance with an example implementation of the present technology;

FIG. 12 is a screenshot of a graphical user interface in accordance with an example implementation of the present technology, illustrating an example pricing and attribute weighting page.

### DETAILED DESCRIPTION

The present disclosure describes systems and methods for providing targeted advertisements based on demographic and situational awareness attributes. For example, a targeted advertisement can be delivered to a user based on demographic attributes (age, gender, ethnicity) associated with a captured digital media file. In another example, a targeted advertisement can be delivered to a user based on situational awareness attributes (environment, weather, location, brand, color) associated with a digital media file. Various examples of the disclosed systems and methods are discussed in detail below. While specific examples are discussed, it should be understood that this is done for illustrative purposes only. The examples are non-limiting and it will be understood that other components and configurations can be used without parting from the scope of the disclosure.

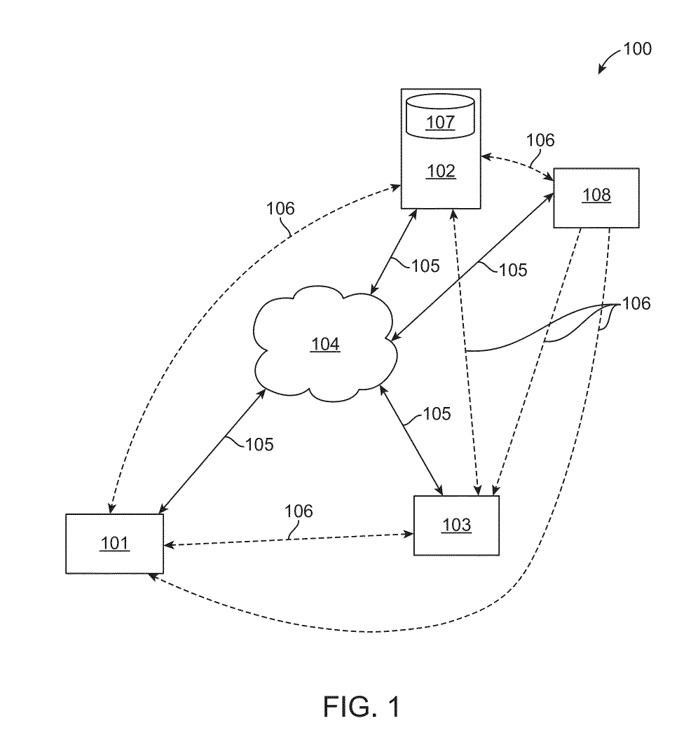

A “digital media terminal” can be any device that is capable of capturing digital media, capturing at least one digital media file, displaying at least one digital media file, accepting data, transmitting data, and executing commands. For example, digital media terminals can include but are not limited to, a digital photo booth, digital image kiosks, or other digital media terminals capable of capturing digital media file, displaying digital media file, accepting data, transmitting data, and executing commands. A digital media terminal can be an “electronic device” as described in the following paragraph. Digital media terminals can include a memory (for example high-speed random access memory, non-volatile memory, flash memory, solid-state memory), one or more central processing units (CPU, which for example can run or execute various software programs and/or sets of instructions stored in memory to perform various functions for the digital media terminal 101), a communication link, an digital media module (for example a still image camera, a moving image camera), a power system (for example, a battery, alternating current (AC) adapter), software components (for example an operating system such as Windows, Linux OS X, UNIX), a display module (for example, a television, computer monitor, liquid crystal display (LCD)). It should be appreciated that digital media terminals can have more or fewer components than shown, can combine two or more components, or can have a different configuration or arrangement of the components. The various components shown in FIG. 1 can be implemented in hardware, software, firmware, or any combination thereof, including one or more signal processing and application specific integrated circuits.

A “digital media file” can be any file or part of a file wherein data is stored in a digital format. The data can be encoded or can be not encoded. A digital media file can include, but is not limited to, a digital image, a digital photograph, a digital video, a digital icon, a digital watermark, an audio file, an audio-video file and a digital advertisement.

An “electronic device” can be any device that is capable of at least accepting data, transmitting data, and executing commands. For example, electronic devices can include, but are not limited to, portable communication devices, mobile communication devices, mobile computers, smartphones, computing pads, tablet computers, personal computers, desktop computers, laptop computers, netbooks, servers, routers, set-top phones, personal digital assistants, or other electronic devices capable of at least accepting data, transmitting data, and executing commands.

A “server” can be any physical computer system dedicated to running one or more services, to serve the requests of other computers or electronic devices on a communications network. Such servers can include, but are not limited to: application servers, web servers, database servers, file servers, communications servers, proxy servers, name servers, home servers, fax servers, mail servers, print servers, game servers or any other type of suitable server. An application server can be dedicated to running certain software applications (for example, a facial recognition software, demographic and situational awareness recognition software or text recognition software). The physical server can be a rack server, tower server, miniature server, home server, mini rack server, blade server, or any other type of server. The server can have the following hardware, one or more central processing units (CPU), one or more of a memory, one or more of a power supply, one or more of a bus, one or more of a network module (such as, LAN module, Ethernet module, Wireless Fidelity module (Wi-Fi), location module (GPS)), one or more of a cooling system (such as, air conditioning, ventilations, fan system). The server can run the following Operating System (OS) software, Windows, UNIX, Linux, OSX, or any other suitable Operating System. The server can also run one or more server software programs, depending on the type of server, such as, application software (Java™, .NET Framework™, or software specific to the application begin hosted on the server), web server software (Apache™ or Internet Information Services IIS™), database software applications (Oracle MySQL™, Sybase™, or any other database software), or any other type of server software programs.

An “advertising service” can be one or more software applications configured to run on a server or configured to run on an electronic device that provides advertisements on-demand based on provided attributes, information or data. The advertising service can take into account a plurality of attributes, information, data and their relating weighting factors when providing an advertisement.

A “memory” can be any transitory memory and non-transitory memory. For example, non-transitory memory can be implemented as Random Access Memory (RAM), Read-Only Memory (ROM), flash, ferromagnetic, phase-change memory, and other non-transitory memory technologies.

A “current location” can be the ability to passively or actively determine the current geographical location of an electronic device. For example, the current geographical location of an electronic device can be determined by using locally available technologies such as, Real-Time Locating System (RTLS), Wireless Personal Area Network (WPAN), Wireless or Wired Local Area Network (LAN) or Digital Enhanced Cordless Telecommunications (DECT). An electronic device can determine its current geographical location by using regionally available technologies such as 3rd Generation Partnership Project (3GPP), Global System for Mobile Communication (GSM) or Long Term Evolution (LTE), or other radio frequency (RF) technologies. An electronic device can be determine its current geographical location by using globally available technologies such as Global Positioning System (GPS), GPS III, Next Generation Control System™ (OCX™), Galileo™, GLONASS™, Compass Navigation System™, Regional Navigational Satellite System™, or any other satellite positioning system. While the above describes specific examples of technologies used to configure an electronic device for determining its current location, it will be appreciated that any other suitable technology by which an electronic device can determine the electronic device's location or determine a relative location of the electronic device can be implemented.

A “communications network” can be a collection of terminals, links, and nodes which connect to enable communication between the users of the terminals. In at least one example, a communication networks is the Internet, a Computer Network, a Telephone Network, an Intranet, an Extranet, the global Telex network, a Local Area Network (LAN), a Wireless Local Area Network (WLAN), a Wide Area Network (WAN), a Metropolitan Area Network (MAN), a Backbone Network, a Campus Area Network (CAN), a Storage Area Network (SAN), a Home Area Network (HAN), a Personal Area Network (PAN), a Wireless Fidelity Network (Wi-Fi), Virtual Private Network (VPN), Virtual Network, Cellular Network, Satellite Network, and Radio Frequency Network (RF).

A “digital media module” can be a device that records visual data. For example, a digital media module can include but is not limited to, a film camera, a digital camera, a Digital Single-Lens Reflex (DSLR) camera, a video camera, a digital video camera, a web camera, or any electronic device having an image capture or video capture capabilities.

An “identifying feature engine” can be one or more software applications for identifying a person or verifying an identify of a person from an image, a video, or any digital medium. For example, Intel® Audience Impression Metrics (AIM) Suite, Google™ Picasa, Apple™ iPhoto, Sony™ Picture Motion Browser (PMB), any facial recognition software application, or any other software applications capable of identifying a person or verifying an identify of a person from a digital medium. While the above describes specific examples of technologies used to identify or verify the presence of a person on a digital medium, it will be appreciated that any other suitable technology that can identify or verify the presence of a person can be implemented.

A “demographic and situational awareness engine” can be one or more software applications for identifying attributes of an image, a video or any other digital media file. A “demographic attribute” can be any attribute identified from a digital media file (for example, a digital image). For example, demographic attributes can be a person, a face, an age, a weight, a height, a hair color, a hair type, a brand, an ethnicity, a gender, the number of people present in a digital media file, a color, a logo, a slogan, an identifiable object (for example, a car, a bicycle, a restaurant) or any other identifiable attributes associated with a digital media file. A “situational awareness attribute” can be any attribute associated with an environment from a digital media file (for example, a video feed). For example, a situational awareness attribute can be an environment, a location, a brand, a city, a country, the weather, the time of day, population density, a retail store, a restaurant, a park, an event (for example, a parade, a party, a holiday), a religious affiliation, or any other identifiable environmental attribute associated with a digital media file.

A “digital watermark” can be a recognizable image or pattern integrated onto a digital medium. Digital watermarks can include, but are not limited to, an image, a logo, or text overlaid onto a digital image creating the appearance of one image. For example, a watermark can be a company logo overlaid onto the bottom portion of a digital image.

A “unique session identifier” (USID) can be a sequence of data used in network communications to identify a session of related message exchanges. The USID can include data comprising, a random number created by a random number generator, a location, an identification number, a sequence number, a date, or a time of the user interaction and creation of the digital media file. This data can extracted from a USID to identify specific parameters of the associated message exchange. For example, the location of a digital media terminal can be extracted from the USID to be provided to the advertising service to aid in selecting an appropriate advertisement. A USID can also be used to keep track of all message exchanges relating to a specific request. For example, a digital media terminal can send a plurality of user data to a server at different time increments. A USID ensures that the plurality of user data remains associated with the original request over the time increments.

The present disclosure provides systems and methods for delivering targeted advertisements based on at least one demographic or situational awareness attribute. In one example embodiment, a targeted advertisement can be based on at least one demographic attribute associated with a digital image or video. In another example embodiment, a targeted advertisement can be based on a current environment via a situational awareness attribute associated with a digital image or video. The system and method can include a digital image or video, at least one demographic or situational awareness attribute, at least one user provided contact information, and at least one type of advertisement.

A digital medium terminal comprising at least one digital media module (for example, a digital camera or digital video camera) can capture a digital media file (for example a digital image or digital video) to determine one or more demographic and situational awareness attributes (for example, gender, age, location, weather) associated with the digital media file. The digital media module can capture a single instance (for example a digital photograph or digital image) or can capture a series of instances (for example, a video or multiple digital photographs, such as in a photo booth). The demographic and situational awareness attributes can be determined locally at the digital medium terminal or remotely at a server. The digital media file can be transmitted to a server for storage in a database. The server can create a unique network address associated with the digital media file to provide access to the digital media file via a communications network (for example, the Internet). An advertisement can be selected based on the one or more demographic or situational awareness attributes and can be transmitted to the user via a user provided contact information, along with the unique internet address associated with the digital media file. The user can access the digital media file via the unique network address after viewing the provided advertisement. In an example embodiment, the demographic attribute can be the user's gender. For example, the digital media file can be captured by the digital media module of a digital medium terminal and transmitted to a server. The server can analyze the digital media file and determine a demographic or situational awareness attribute (for example, the user's gender is male). An advertisement service running locally on the server or remotely on an advertisement server can select an advertisement associated with the attribute: the user's gender is male. The advertisement, along with the unique network address can be transmitted to the user via a user provided contact information. In another example embodiment, the demographic and situational awareness attribute associated with a user can include, but is not limited to, age, weight, location, hair color, hair type, height, ethnicity, number of people present in a digital medium, a color, a brand, an environment, current location, or current weather, where the described demographic attribute generates an advertisement specific to the determined demographic attributes.

A digital media file can be analyzed in several ways to determine one or more demographic or situational awareness attributes. In one example, the digital media file can be analyzed by an identifying feature engine (for example, facial recognition software) to determine the number of user faces present in the digital media file. The users of a digital media terminal can then be prompted, by the digital media terminal, to input the user contact information (for example, email address) related to the user's recognized face. The facial recognition software can also determine attributes including, but not limited to, age, weight, hair color, hair type, height, and ethnicity. In another example, the digital media file can be analyzed by text recognition software to determine relevant demographic attributes of the user or the user's environment. The software used to determine demographic or situational awareness attributes can be executed locally on the digital media terminal or remotely on a server.

Implementations of the technology can provide an advertising service that can analyze at least one demographic or situational awareness attribute and select an advertisement targeted based on the demographic attribute. The advertising service can be executed locally or remotely (for example, the advertising service software can be executed on a digital media terminal, a remotely located server, or an independent advertising server). In an example embodiment, the digital media file can be captured by a digital media terminal located at a baseball game. The advertising service can select the local baseball team's advertisement based on the situational awareness attribute of a baseball game is being played at the local team's stadium. In another example embodiment, the advertisement service can select an advertisement for a men's clothing store based on a demographic attribute indicating the user is male and the situational awareness attribute indicating the user's location is near the men's clothing store.

The present disclosure also provides a method and system for enabling dynamic pricing of advertisements. In one example embodiment, companies can bid to display advertisements based on previously designated demographic and situational awareness attributes. In another example, a company can select one or more weighted attributes to have associated with their advertisements. The advertisement service, during the advertisement selection process, can analyze the previously designated attributes, the previously designed attribute weights and the bids assigned to all advertisements. The advertisement service, can then select the advertisement that best matches the criteria for attributes and has the highest bid.

The present disclosure also provides a method and system for enabling competitions between two or more digital media terminals. In one example, two or more digital media terminals can interact with each other via a communication network, and compete in an assigned challenge to win a prize (for example, a discount coupon or voucher). In one example, a server can challenge the users of two or more digital media terminals to see which digital media terminal can get the most people in the digital media file. The captured digital media file will use facial recognition to determine the number of users in each digital media file and can require each user to input their contact information (for example, email address). The users who win the challenge are transmitted a reward (for example, an advertisement with a discount coupon) via their provided contact information. The users at the digital media terminals that did not win can be transmitted a runner-up reward (for example, an advertisement with a discount coupon of a smaller denomination).

The present disclosure provides at least one graphical user interface that advertisers can use to submit their proposed advertisements. The graphical user interface can provide the advertisers with one or more templates for formatting their advertisements. The templates can ensure uniform distribution for all user capable devices (for example, templates can be formatted for optimal viewing on mobile device). In one example embodiment, a company can submit their advertisement on a preapproved watermark template ensuring the advertisement is displayed correctly on the digital media file transmitted to the user.

For a better understanding of the embodiments described herein and to show more clearly how they may be carried into effect, reference will now be made, by way of example only, to the accompanying drawings which show the exemplary embodiments and implementation of the present technology in relation to FIGS. 1-12.

FIG. 1 is a block diagram representing an example embodiment 100 of a system configured to deliver a targeted advertisement based on at least one demographic and situational awareness attribute of a user. The system can include a digital media terminal 101 with a digital media module (not shown) communicatively linked to a server 102, an advertising server 108, and an electronic device 103 via a communication network 104. It should be appreciated that alternate embodiments can have numerous variations from that described above (for example, the server 102 and advertising server 108 can be combined into a single server). For example, in FIG. 1, the digital media terminal 101 can interact with the server 102, an electronic device 103, and an advertising server 108 via a communication network 104. Digital media terminal 101, server 102, electronic device 103 and advertising server 108 can have a communication module (not shown) to connect with communication network 104 via a communication link 105. For example, the communication module can include, but is not limited to, an Ethernet or landline module, Wireless Fidelity module (Wi-Fi), mobile telecommunication module, cellular communication module or any other module that can transmit and receive data from communication network 104. Additionally, the digital media terminal 101 can connect to the server 102, the electronic device 103, and the advertising server 108 via wireless link 106. Wireless technologies can include, but are not limited to a mobile telecommunication module, cellular communication module, a Wireless Fidelity (Wi-Fi), Bluetooth™, Near Field Communication (NFC), or any other module that can transmit and receive data between digital media terminal 101, server 102, electronic device 103, and the advertising server 108.

Server 102 can store and retrieve data from an accessible database 107. Database 107 can be stored locally in server 102 or can be remotely accessible via communication network 104 or wireless link 106. Database 107 can also be located in advertising server 108. Database 107 can store data relating to each unique session identifier (for example, contact information, demographic attributes, situational awareness attributes, facial recognition attributes, digital media file, unique network address, and advertisements).

In one example embodiment, digital media terminal 101 captures a digital media file via digital media module (not shown). Digital media terminal 101 can execute an identifying feature engine (for example, facial recognition software) that can determine the presence of the individuals in the digital media file, and prompt the users of digital media terminal 101 to input contact information for each of the recognized individual. The facial recognition software can be executed locally at digital media terminal 101 or remotely at server 102. At least one demographic or situational awareness attribute can be determined and associated with the digital media file. The at least one demographic or situational awareness attribute can be determined at digital media terminal 101, server 102, or advertising server 108. The demographic and situational awareness attributes can be stored in database 107. The attributes stored in database 107 can be used by the advertising server 108 to selected a targeted advertisement to deliver to electronic device 103 along with the unique network address containing the digital media file via the user contact information provided at digital media terminal 101. The advertisements delivered can be a survey or require a question be answered before the unique network address and digital media file are accessible. The feedback provided from the survey or questions from electronic device 103 can be transmitted to server 102 or advertising server 108 and stored in database 107.

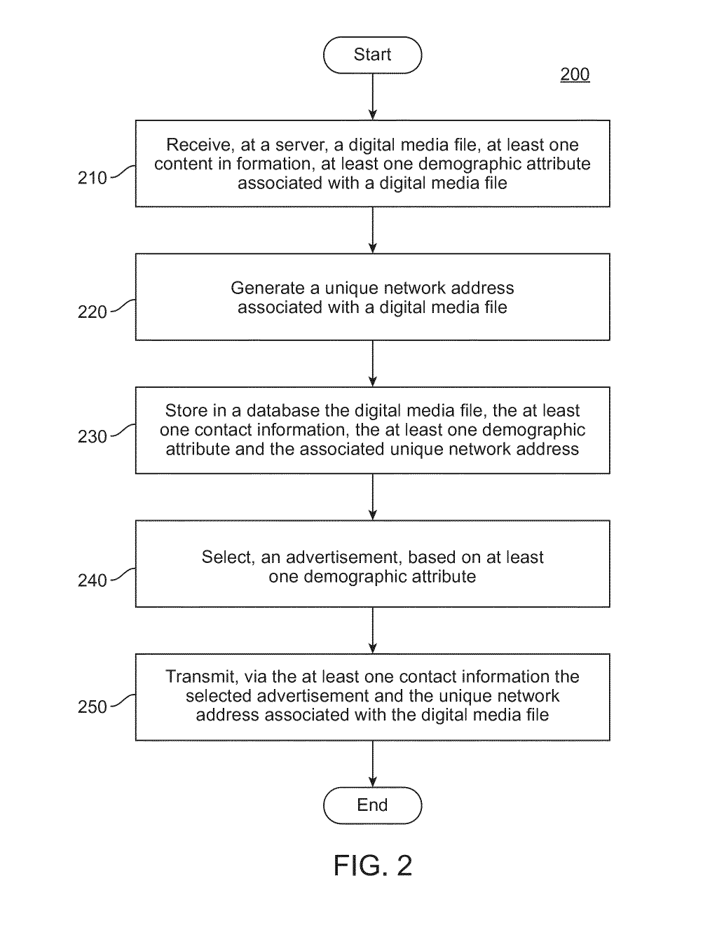

FIG. 2 is a flow chart of an example method of delivering targeted advertisements based on demographic and situational awareness attributes. The method 200 illustrated in FIG. 2 is provided by way of example, as there are a variety of ways to carry out the method. Additionally, while the example method is illustrated with a particular order of steps, those of ordinary skill in the art will appreciate that FIG. 2 and the steps illustrated therein can be executed in any order that accomplishes the technical advantages of the present disclosure and can include fewer or more steps than illustrated.

Each block shown in FIG. 2 represents one or more processes, methods, or subroutines, carried out in example method. The steps illustrated in FIG. 2 can be implemented in a system including a digital media terminal 101, a server 102, an electronic device 103, a database 107, and an advertising server 108. Additional steps or fewer steps are possible to complete the example method. Each block shown in FIG. 2, can be carried out by digital media terminal 101, server 102 and electronic device 103 illustrated in FIG. 1. The method illustrated in FIG. 2 will be described in relation to and making reference to digital media terminal 101, a server 102, an electronic device 103, a database 107, and an advertising server 108.

Method 200 can begin at block 210. At block 210, a server receives a digital media file, at least one contact information, and at least one demographic or situational awareness attribute associated with the digital media file (for example, the digital media file can be a digital image or digital photograph comprising a woman holding a shopping bag from the retail store fashion world). The contact information can be submitted by the user (for example, the contact information can be an email address of the user). The demographics and situational awareness attribute can be associated with the digital media file (for example, the demographics and situation awareness attributes can be a gender attribute, female, and retail attribute, fashion world). When the server 102 receives a digital media file, at least one contact information, and at least one demographic or situational awareness attribute associated with the digital media file at block 210, the method can move to block 220.

At block 220, server 102 creates and associates a unique network address with the digital media file. The unique network address associated with the digital media file can provide access to the digital media file from communication network 104. The unique network address can be created using information provided from digital media terminal 101 (for example, a digital media terminal identifier, a digital media terminal location, a digital media file identifier, a random number generator, an MD5sum of the digital media file, any way or combination of creating a unique network address. After the unique network address is generated and the associated with the digital media file at block 220, the method can proceed to block 230.

At block 230, the server 102 stores, in a database 107, the digital media file, the at least one contact information, the at least one demographic or situational awareness attribute, and the associated unique network address. Server 102 can transmit and receive data from database 107 via internal system bus (for example, if database is located locally), via a communication link 105 or wireless link 106 (for example, if database is located remotely). In another example embodiment, database 107 can be a cloud-based system connected to communication network 104 (for example, Amazon cloud drive, Microsoft SkyDrive, or Apple iCloud). After the server stores the associated data at block 230, the method can proceed to block 240.

At block 240, server 102 can select an advertisement based on the at least one demographic or situational awareness attribute. Server 102 can compare the demographic and situational awareness attributes associated with the digital media file with the demographic and situational awareness attributes associated with the stored advertisements. For example, the digital media file can have associated demographics and situation awareness attributes of gender attribute, female, and retail attribute, fashion world. These attributes can be compared with attributes assigned to the stored advertisements and an advertisement that best matches the attributes can be selected (for example, sale items at fashion world). The advertisement selection can also be performed at advertising server 108 or digital media terminal 101. For example, the demographics and situation awareness attributes can be transmitted from server 102 and received at advertising server 108. Advertising server 108 can then compare the received attributes, with attributes stored locally, in database 107, or in an advertising database (not shown). The selected advertisement can then be transmitted to server 102. After an advertisement based on the at least one demographic or situational awareness attribute has been selected at block 240, the method can proceed to block 250.

At block to 250, server 102 can transmit via the communication network 104 the selected advertisement and the unique network address associated with the digital media file to the user via the at least one contact information. For example, the advertisement and the unique network address can be transmitted to an email address provided from the user. The user can view the advertisement and retrieve the digital media file via the unique network address on electronic device 103. In another example embodiment, the advertisement and unique network address can be transmitted to an electronic device via Short Message Service (SMS), Multimedia Message Service (MMS), or any other means of transmission are possible. After an advertisement and unique network address are transmitted from server 102 at block 250, the method can end.

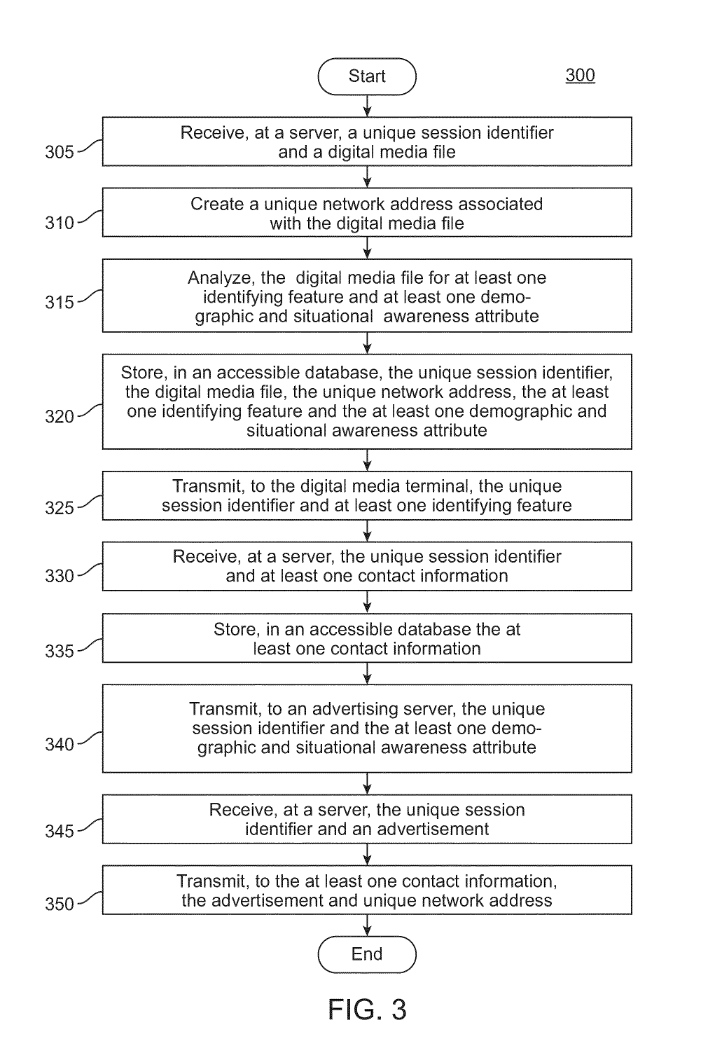

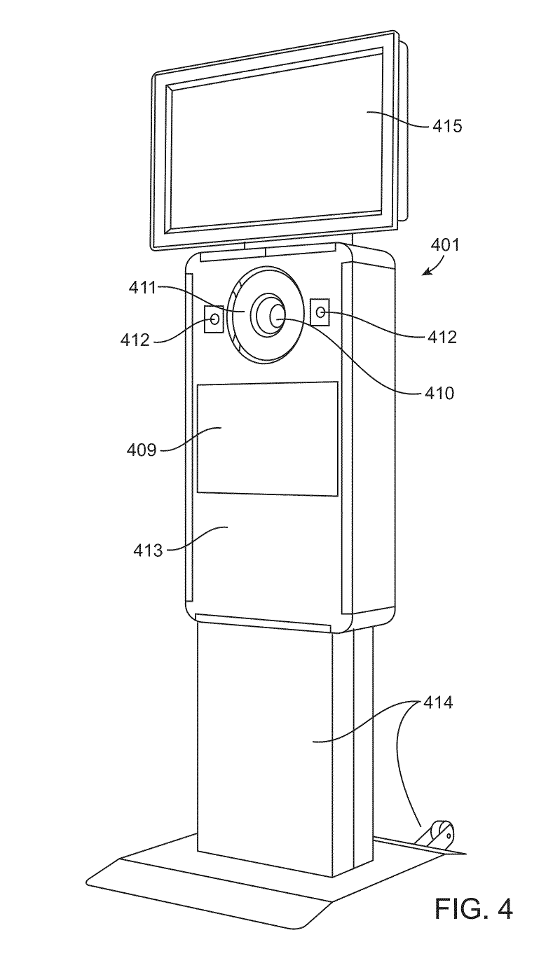

FIG. 3 is a flow chart of an example method of creating and delivering targeted advertisements based on demographic and situational awareness attributes. Additionally, while the example method is illustrated it will be appreciated that FIG. 3 and the steps illustrated therein can be executed in any order that accomplishes the technical advantages of the present disclosure and can include fewer or more steps than illustrated.

Each block shown in FIG. 3 represents one or more processes, methods, or subroutines, carried out in example method. The steps illustrated in FIG. 3 can be implemented in a system including a digital media terminal 101, a server 102, an electronic device 103, a database 107, and an advertising server 108. Each block shown in FIG. 3, can be carried out by digital media terminal 101, server 102, electronic device 103, and an advertising server 108 illustrated in FIG. 1.

Method 300 can begin at block 305. At block 305, a digital media file and a unique session identifier (USID) associated with the digital media file are received at server 102. The USID identifies and organizes all data transmitted and received during a particular session for delivery of a targeted advertisement. For example, USID can be a combination of the identifier of digital media terminal 101 and a unique number associated with the digital media file (for example an MD5sum or an incremented number). The USID also can make sure all the associated data is stored and linked in database 107. After, a digital media file, and a unique session identifier (USID) associated with the digital media file are received at server 102 at block 305, the method can proceed to block 310.

At block 310, server 102 creates and associates at least one unique network address with the digital media file. The unique network address can be used to access the digital media file via a communication network (for example, a unique network address can be a uniform resource locator). The unique network address can be created using the USID, a random number generator, an MD5sum or checksum of the digital media file, or any of way of creating a unique network address. The unique network address can also be created by a third party company hosting the digital media file (for example, for example, Amazon cloud drive, Microsoft SkyDrive, or Apple iCloud). After the unique network address is generated and the associated the digital media file at block 310, the method can proceed to block 315.

At block 315, an identifying feature engine and a demographics and situational awareness engine can analyze the received digital media file for at least one or more identifying feature and one or more demographics and situational awareness attributes. The identifying feature engine can be a facial recognition software program (for example Intel® Audience Impression Metrics (AIM) Suite, Google™ Picasa, Apple™ iPhoto, or Sony™ Picture Motion Browser (PMB). The demographics and situational awareness engine can be a software program used to analyze and determine attributes of a digital media file. For example, the digital media file can be a digital photograph comprising two people in baseball jerseys at a baseball game. The identifying feature engine can analyze the photo and identify two faces in the photograph. The demographics and situational awareness engine can analyze the digital photograph and identify the team of the baseball jerseys and the location of the baseball game. When the identifying feature engine and demographic or situational awareness attribute engine determine at least one identifying feature and at least one demographics and situational awareness attribute at block 315, the method can move to block 320.

At block 320, server 102 can store the unique session identifier, the digital media file, the unique network address, the at least one identifying feature and the at least one demographic and situational awareness attribute in accessible database 107. When the data is stored in database 107 at block 320, the method can move to block 325.

At block 325, the unique session identifier and the at least one identifying feature are transmitted to digital media terminal 101. Digital media terminal 101, displays the identifying feature (for example, image of the face identified) and can ask the user for at least one contact information (for example, an email address, a telephone number, a messaging identifier, or any method of electronic communication). The user can enter their contact information via a touchscreen keyboard or any other suitable input device. When at least one datum of contact information is entered at block 325, the method can move to block 330.

At block 330, server 102 receives the USID and at least one contact information for digital media terminal 101. When server 102 receives the USID and at least one contact information at block 330, the method can move to block 335.

At block 335, server 102 stored the at least one contact information in accessible database 107. Server 102, can use the USID to query the database for the appropriate entry. Server 102 can then store in database 107 the at least one contact information and it can be associated with the digital media file, the unique network address, the at least one identifying feature and the at least one demographic and situational awareness attribute. When the at least one contact information is stored in accessible database 107 at block 335, the method can move to block 340.

At block 340, server 102 can transmit to advertising server 108 the USID and the at least one demographic and situational awareness attribute. Advertising server 108 can receive the USID at the at least one demographic and situational awareness attribute and can select an advertisement targeted at the specific user. For example, advertising server 108 can receive the attributes of a baseball team and a baseball game location. Advertising server 108 can then query all available attributes and advertisements and can select an advertisement targeted at the user with the provided attributes (for example, an advertisement for discount tickets for the next baseball game played by the team in the attributes). After advertising server 108 selects an advertisement at block 340, the method can move to block 345.

At block 345, server 102 receives from advertising server 108 the USID and the selected advertisement. Server 102 can query accessible database 107 for the USID and retrieve the digital media file, the unique network address and the contact information associated with the USID. Server 102 can then package the advertisement, the digital media file, the unique network address into a format desirable by the user. For example, server 102 can combine the digital media file with a watermarked advertisement to provide to the user. Server 102 could also, embed the unique network address with a full-size advertisement causing the user to view the advertisement in order to view the digital media file. Once server 102 receives the advertisement and creates a user-desirable advertisement package at block 345, the method can move to block 350.

At block 350, server 102 can transmit via the communication link 105 or short-range wireless 106 the user desirable advertisement package comprising the digital media file, unique network address, and advertisement to the user contact information. For example, the user desirable advertisement package can be transmitted to the user's email address. The user can then open the email and the advertisement and view their digital media file by the unique network address. The user desirable advertisement package can also be transmitted via Short Message Service (SMS) or Multimedia Message Service (MMS). While an email, SMS, or MMS can used to transmit the user desirable advertisement package any other methods of transmitting electronic data can be implemented. When server 102 has transmitted the user desirable advertisement package, method 300 can end.

FIG. 4 is an illustration representing an example digital media terminal. Digital media terminal 401 can include, but is not limited to, a touch sensitive display 409 (for example, touch sensitive display can detect inputs via capacitive, resistive, infrared, surface acoustic wave technologies, or any other technology by which inputs can be detected), a image module 410 (for example, a DLSR camera that can capture a digital media file, still or moving images), flash module 411 (for example, a flash ring mounted around the image module 410 providing lighting for digital media capture), a peripheral image module 412 (for example, a web camera that can capture or stream a digital media file, still or moving images, of the digital media terminal's surrounding environment for detecting situational awareness attributes), a protective casing 413 (for example, a housing to shield the individual components of the digital media terminal from the environment. The protective casing 413 can be a custom fabricated aluminum and steel enclosure. The front and back panels can be acrylic with a vinyl backing allowing for customized graphics on the physical face of the unit. The protective casing 413 can also be wrapped in vinyl for branding on the sides and base. The protective casing 413 can also include hardware to support mounting the digital media terminal 401 to another surface.), a support base (For example, can include a metal structure acting as a stand to ensure unit is securely placed. Support base 414 can be mounted to the flooring surface to increase support or can have wheels to increase portability) and auxiliary display 415 (for example, a flat screen monitor that can display advertisements, images, or interact with the digital media terminal 401 environment. Auxiliary screen 411 can display advertisements based on input from the peripheral image module 409 or image module 407). The digital media terminal can also include a communication module (not shown) for receiving and transmitting data relating to the digital media terminal. For example, the communication module can be a router for communicatively linking the digital media terminal 401 and a communication network. For example, the communication module (not shown) can be a Wi-Fi adapter or an Ethernet adapter for connecting to the Internet.

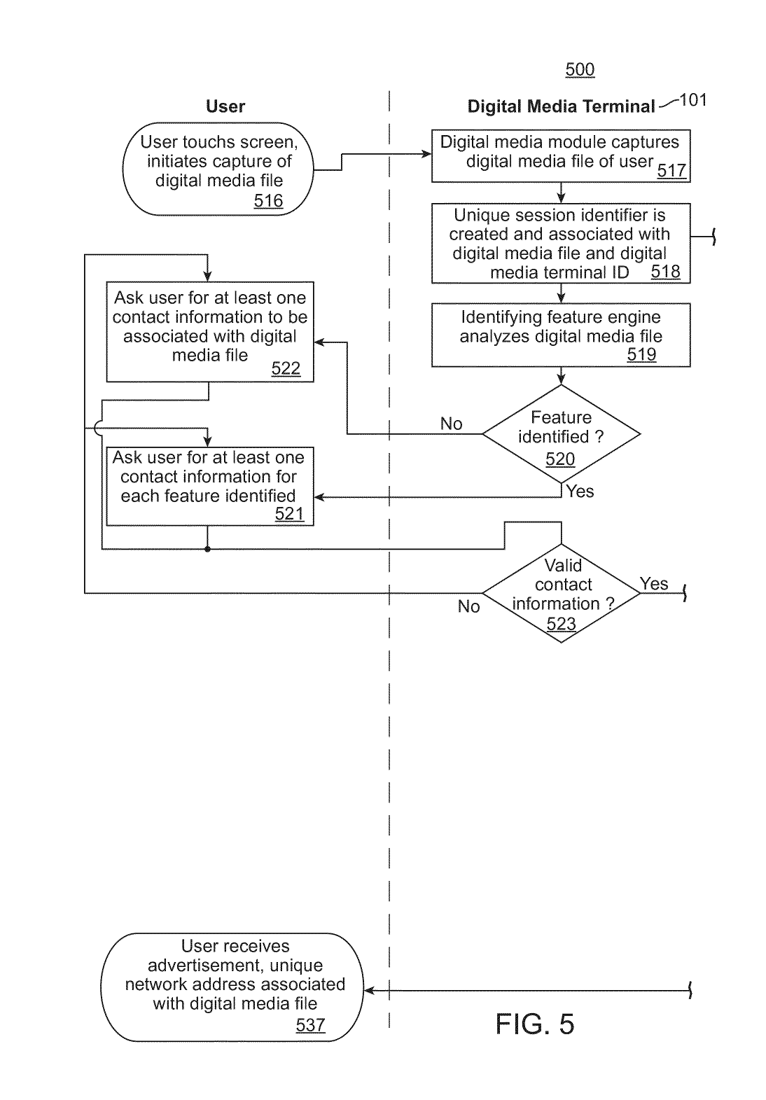

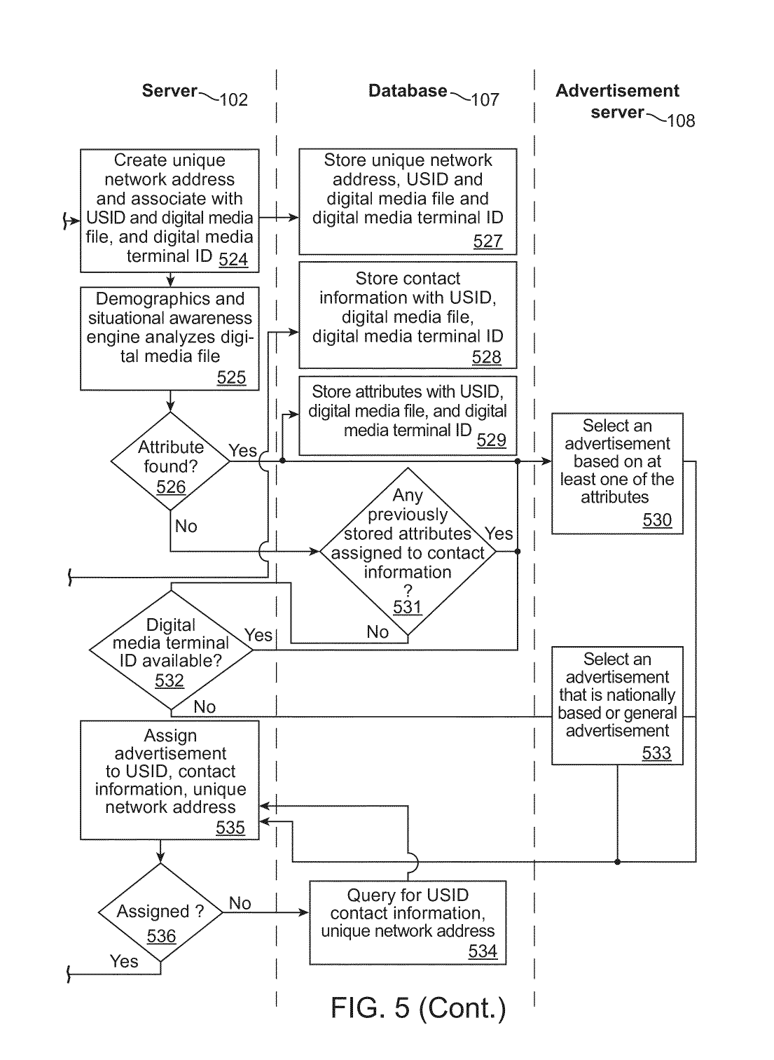

FIG. 5 is a flow chart of an example method of delivering targeted advertisements based on demographic and situational awareness attributes. The method 500 illustrated in FIG. 5 is provided by way of example, as there are a variety of ways to carry out the method. Additionally, while the example method is illustrated with a particular order of steps, it will be understood that the steps illustrated therein can be executed in any order that accomplishes the technical advantages of the present disclosure and can include fewer or more steps than illustrated.

Each block shown in FIG. 5 represents one or more processes, methods, or subroutines, carried out in example method. The steps illustrated in FIG. 5 can be implemented in a system including a digital media terminal 101, a server 102, an electronic device 103, a database 107, and an advertising server 108. Each block shown in FIG. 5, can be carried out by digital media terminal 101, server 102, electronic device 103, database 107, and an advertising server 108 illustrated in FIG. 1.

Method 500 can begin at step 516. In step 516, a user can touch the screen of digital media terminal 101 and initiate the capture of a digital media file. Digital media terminal 101 can also be used to actively record the surrounding environment via a peripheral image module (for example a web camera) during execution of some or all of the method.

In step 517, digital media terminal 101 can capture a digital media file (photograph or image) of the user who initiated the method in step 516 via a digital image module. When the digital media file has been captured at step 517, the method can move to step 518. In step 518, digital media terminal 101 can generate a unique session identifier (USID) associated with the digital media file. The digital media terminal 101 can also associated a digital media terminal identifier (for example, a serial number) with the digital media file. When the USID has been created and associated with the digital media file in step 518, method can move to step 519 and can also move to step 524.

In step 519, an identifying feature engine (for example, facial recognition software) can analyze the digital media file to determine the number of faces in the digital media file. It should be known that the identifying feature engine can be executed on digital media terminal 101, server 102, advertisement server 108, or any combination of the aforementioned. The identifying feature engine can also compare the identified faces with a database of previously identified faces. If a match is found, the identifying feature engine can request the associated data with the identified face (for example, contact information, demographic or situational awareness attributes, and previous digital media files). After the identifying feature engine completes the analyses of the digital media file in step 519, the method can move to step at 520. In step 520, the identifying feature engine determines if a identifying feature was identified. If a feature is identified (for example, a face) via the identifying feature engine in step 519, the method can move to step 521. If a feature is not identified the method can move to step 522.

In step 521, the digital media terminal can display, via touchscreen, the digital media file and the identified features identified in step 519. The digital media terminal asks each identified user to enter their contact information (for example, an email address, telephone number, messenger id or any other form of electronic communication) via an approved input (for example, touchscreen keyboard, Near-Field Communication, Bluetooth™, short-range wireless or machine-readable code). In step 522, the digital media terminal can display the digital media file and ask for at least one contact information for the at least one known user that initiated method 500. After the at least one contact information was entered in step 521 or 522, the method can move to step 523.

In step 523, the digital media terminal can determine if the contact information is valid. If the contact method is not valid, step 523 returns to previous step 521 or 522. If the contact information is valid in step 523, the method can move to step 528.

In step 528, the USID and at least one datum of contact information are transmitted and stored in accessible database 107. It should be known that digital media terminal 101 can directly transmit and store the data in database 107 or the data can first be transmitted to server 102 or advertising server 108 and then stored in database 107. It should also be known that database 107 can be located internal or external to digital media terminal 101, server 102 or advertising server 108. When the data is stored in database 107 in step 528, this branch of the method can end.

In step 524, server 102 receives from digital terminal 101 at step 518, the digital media file, the associated USID, and the digital media terminal identification. When the digital media file and the USID are received, server 102 generates a unique network address (for example a uniform resource locator) associated with the digital media file. The unique network address can be used to access the digital media file from any electronic device with access to a communication network (for example, the Internet). When a unique network address is generated and associated with the digital media file in step 524, the method can move to step 527 and step 525.

In step 527, the digital media file, the USID, and the digital media terminal identification are stored in accessible database 527. It should be known that server 102 can directly transmit and store the data in database 107 or the data can first be transmitted to digital media terminal 101 or advertising server 108 and then stored in database 107. It should also be known that database 107 could be located internal or external to digital media terminal 101, server 102 or advertising server 108. When the data is stored in database 107 in step 523, this branch of the method can end.

In step 525, a demographics and situational awareness engine (for example, software that can extract gender, ethnicity, hair color, brand logos, weather, location or any discerning information from a digital media file) can analyze the digital media file. The demographic and situational awareness engine can be executed on digital media terminal 101, server 102, advertisement server 108, or any combination of thereof. After the demographic and situational awareness engine analyzes the digital media file at step 525, the method can move to step 526. In step 526, the demographic and situation awareness engine determined if a demographic and situational attribute was found. If an attribute was identified in step 526, the method can proceed to steps 529 and 530. If an attribute was not identified in step 526, the method can proceed to step 531.

In step 529, server 102 can store the USID and demographic and situational awareness attributes identified in database 107. It should be known that server 102 can directly transmit and store the data in database 107 or the data can first be transmitted to digital media terminal 101 or advertising server 108 and then stored in database 107. It should also be known that database 107 could be located internal or external to digital media terminal 101, server 102 or advertising server 108. When the data is stored in database 107 in step 523, this branch of the method can end.

In step 530, an advertising server receives the USID and at least one demographic and situational awareness attribute. The advertising server can select from the at least one demographic and situational awareness attribute and advertisement targeted to a user within the attributes provided. Advertisements can be stored in an advertising database (not shown) or in accessible database 107. Advertisers can have the ability to weight attributes that are more important for their business. For example, a baseball team can weight the attribute of their logo, team name or baseball stadium location higher than any other attributes. This can help their advertisements only be sent to people who are interested in the baseball team. In another example, the advertising server can receive a digital media terminal identification and an associated location for selecting an advertisement. When an advertisement is selected in step 530, the method can move to step 535.

In step 531, if a demographic and situational awareness attribute was not found in step 526, server 102, can query database 107 for the USID and retrieve the user's contact information. Server 102 can then query database 107 for the user's contact information and retrieve any previous entries relating to user's contact information and the associated demographics. The previously identified attributes can then be transmitted to the advertisement server in step 530. If a previous entry with the user' contact information was not identified in step 531, the method can move to step 532.

In step 532, server 102 verifies the digital media terminal identification is available. If digital media terminal identification is available (from step 524 or retrieval of the identification from database 107 via USID) the location of the digital media terminal is extracted from the identification (for example, the location data can be latitude and longitude coordinates in the identification, or the location information can be retrieved from database 107 or another database for storing digital media terminal information). If the location information is available in step 532, the method can move to step 530. If the digital media terminal identification is not available in step 532, the method can move to step 533.

In step 533, advertising server 108 can receive a USID and a notification that no demographic and situational awareness attribute was available. The advertisement server can then select a nationally-based or general advertisement. When advertisement is selected in step 533, the method can move to step 535.

In step 535, an advertisement and a USID is received at server 102. The advertisement can be associated with the at least one contact information and unique network address already associated with USID. After an advertisement and USID are received at server 102 and associated with at least one contact information and unique network address in step 535, the method can move to step 536. At step 536, server 102 verifies an advertisement associated with a USID is assigned to at least one contact information and unique network address associated with the same USID. If an assigned was validated in step 536, the method can move to step 537. If an assigned was not validated in step 536, the method can move to step 534.

In step 534, server 102 queries database 107 for USID and the associated contact information and unique network address. After the associated contact information and the unique network address are retrieved from database 107, the method can return to step 535.

In step 537, server 102 packages and transmits an advertisement, a digital media file and an associated unique network address at the at least one contact information previously provided. For example, server 102 can combine the digital media file with a watermarked advertisement to provide to the user. Server 102 could also, embed the unique network address with a full-size advertisement causing the user to view the advertisement in order to view the digital media file. When server 102 transmits the advertisement, digital media file and associated unique network address to the at least one contact information in step 537, the method can end.

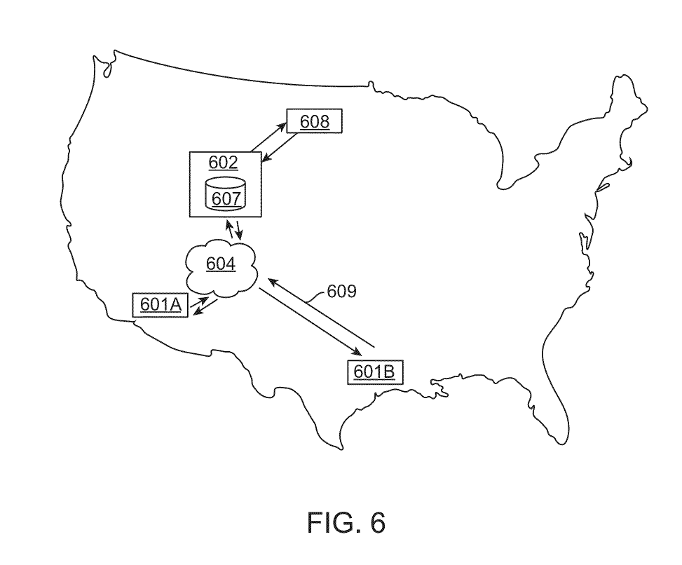

FIG. 6 is a block diagram of an example method and system for a competition between two digital media terminals. The competitions can include, but are not limited to, getting the most number of people in a digital media file, most number of people wearing a particular color or logo in a digital media file, most girls or guys in a digital media file or any type of competition involving demographic and situational awareness attributes. The digital media terminals 601a, 601b (for example 101) and server 602 (for example, 102) can be connected through a communication network 604. Server 602 can transmit and receive data between the two digital media terminals 601, store data in the accessible database 607, and select a competition for the digital media terminals 601a and 601b. Competitions can be initiated via server 102 and any digital media terminal 601. Server 602 can initiate a competition based on situational awareness attributes received from a peripheral image module (for example, a web camera can stream data to server 602 which the situational awareness engine can analyze and determine if a competition can boost advertisement). For example, the situational awareness engine can determine that two cities are playing a baseball game a digital media terminal 601 in each city can be entered in a competition against each other. In another example, the situational awareness engine can determine that two digital media terminals are located in heavily populated areas. A competition can be initialized to produce a digital media file with the highest number of people captured in the digital media file. In another example, a competition can be initialized by the user of a digital media terminal.

During a competition, the digital media terminal 601a and 601b can capture a digital media file and analyze the digital media file for identifying features and demographic and situational awareness attributes. Digital media terminals 601a and 601b can display the identifying features (for example, identified faces) and collect user contact information associated with the identified features. Server 602 can receive the contact information and specific demographic attributes, for which the competition is based, of the two digital media files. The analyses of the digital media files can be performed by digital media terminal 601a and 601b, server 602, advertising server 608, or any combination of the aforementioned. Server 602 can store the digital media files and all associated data in accessible data 607 (for example, digital media file, USIS, unique network address, demographic and situational attributes, and contact information). Server 602 can analyze the demographic and situational awareness attributes from the digital media files provided and determine a winner of the competition. Server 602 can request from advertisement server 608 an advertisement based on the demographic and situational awareness attributes. Server 602 can also request a consolation advertisement to provided the runners-up in the competition. The digital media terminal 601a and 601b can also display via their auxiliary screens a streaming media feed from the peripheral image module of the opposing digital media terminal. This can help aid the competition as the users in the competition can view who they are competing against. This can be a direct digital media terminal to digital media terminal stream or it can be provided via server 602.

In an example embodiment, server 602 can select a digital media terminal 601a located in Arizona and digital terminal 601b located in Texas to have fans compete in a competition to see who can get the most people in a digital media file during a baseball game where the Arizona team is playing the Texas team. The users in each location can view the users in the other location via the auxiliary screen and determine if they need to get more people in their digital media file. Each respective digital media file can be transmitted to the server 602 and stored in the database 607. The digital media files can be processed through a identifying feature engine (for example, facial recognition software) to determine the number of users in each digital media file. Digital media terminals 601a and 601b can require each user to input contact information for the recognized people in order to display the winner. The contact information can be sent to server 602 via communication network 604, and stored in database 607. Server 602 can also request a prize and advertisement from the advertising server 608 based on the collected demographic and situational awareness attributes of each digital media file. The winners of the competition, are then sent a prize and advertisement via the entered contact information. The users who did not win the competition can also be sent a consolation prize and advertisement. For example, the prizes can include, but are in limited to, a discount off of the price of team merchandise, discounted future tickets, or discounted concessions. The users can each be sent a reward, a targeted advertisement, and a unique network address associated with the digital media file via the entered contact information. In another example, the prize can be an advertisement with an integrated coupon on discount. Server 602 can base competitions on known rivalries between digital media terminals in different cities, sports teams, or geographic regions. The competitions can also be randomly selected digital media terminals. In another example, normal operation of the digital media terminal will not continue until a competition is completed.

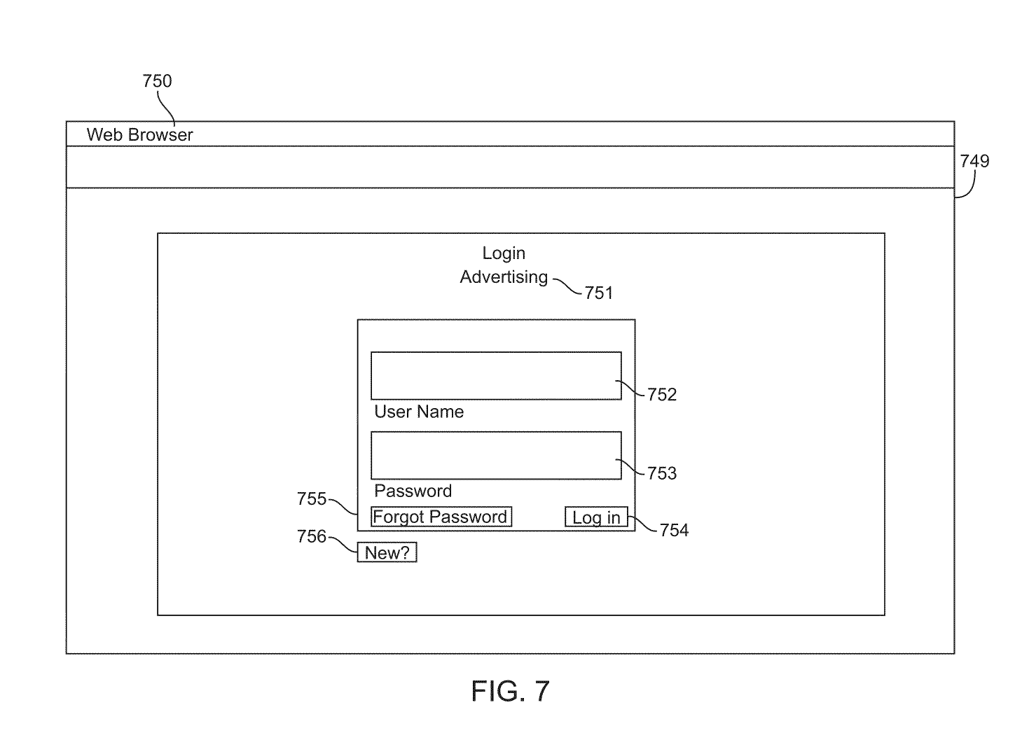

FIG. 7 is an example graphical user interface 749 login screen for managing and submitting advertisements for use on digital media terminals. An advertiser can visit the digital media terminal advertising management webpage, and be prompted by the login screen shown in FIG. 7. For example, the advertiser can use a web browser 750 to navigate to the digital media terminal advertising homepage. The digital media terminal advertising webpage can manage an advertisers current advertisements and attributes associated with their advertisements. Upon navigating to the home page an advertiser would see company title and logo 751. The advertiser can then enter their username 752 and password 753 to complete login 754. If the advertiser has forgotten their password, they can select the Forgot Password option 755. New advertisers seeking to create an account can proceed through the New option 756. For example, an Arizona baseball team can enter its username 752 and password 753 to login 754 and enter the advertising graphical user interface.

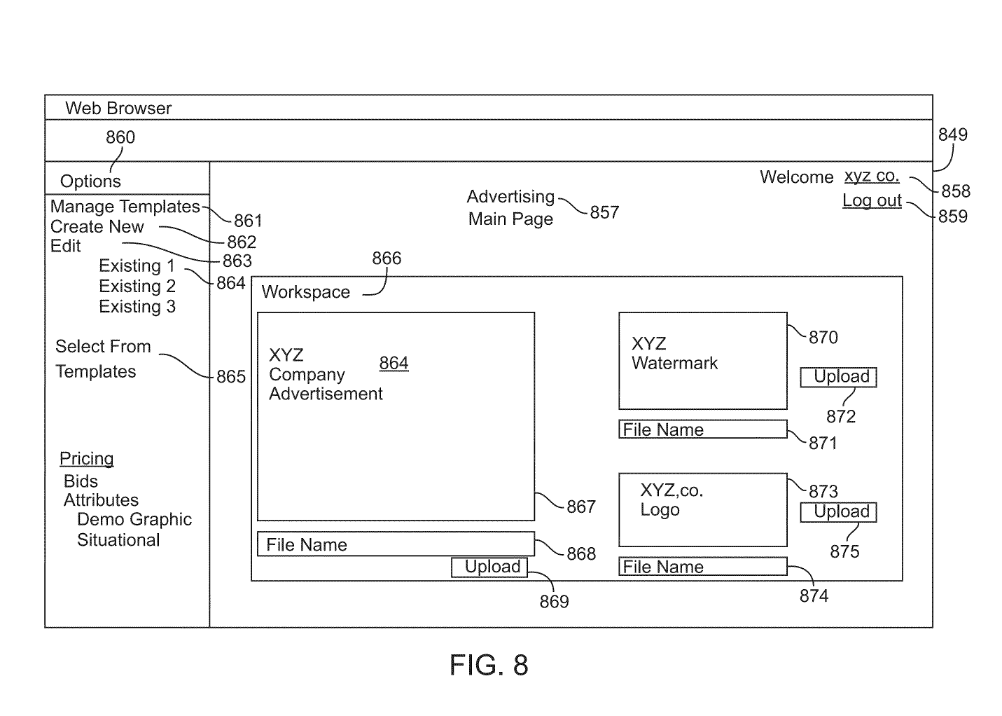

FIG. 8 is an example graphical user interface 849 of main page 857 for managing advertisements for use with digital media terminals. The main page 857 can appear after an advertiser successfully logins, or creates a new account. The advertiser can see a welcome message 858 indicating the advertiser is properly logged in, and a log out option 859 which can end the advertiser's current session. The advertiser can also see an options menu 860. Option menu 860 can be used to manage advertisements templates 861. A plurality of template can be made available for advertisers in order to provide optimum viewing on the digital media terminal and electronic devices. Manage templates 861 can be used create new, view, edit or delete current templates. Advertisers can create new templates 862, edit templates 863 including existing templates 864, or select from existing prebuilt templates 865. The create new template 862 option can be used by advertisers to create a new template from scratch. The edit templates 863 option can offer advertisers the ability to alter the existing advertisements and templates previous used. The prebuilt templates 865 can present the user with a plurality of prebuilt templates to aid in building their advertisement. The main page 857 can also provide a work space 866 where an advertiser can see their current advertisement selected 867, upload a file for advertisement 868, and execute the upload 869. The workspace 866 can also offer an opportunity to see the current watermark 870, choose a new watermark file 871, and upload 872, and an opportunity to see the current advertising logo 873, choose a new logo 874, and upload 875 the logo. For example, after logging in an Arizona baseball team can be see their main page 857 with an options menu 860 displaying their current advertisements 864. The Arizona baseball team can also create a completely new advertisement 862, or select an existing template 865. In the workspace 866, Arizona baseball team can manage their advertisement, digital watermark, and company logo. They can change the advertisement by choosing a new file 868 and uploading it 869. The new advertisement will display in the workspace 866 advertisement window 867. The Arizona baseball team can also change their digital watermark 870, or company logo 874 by uploading a new one 872 and 875 respectively.

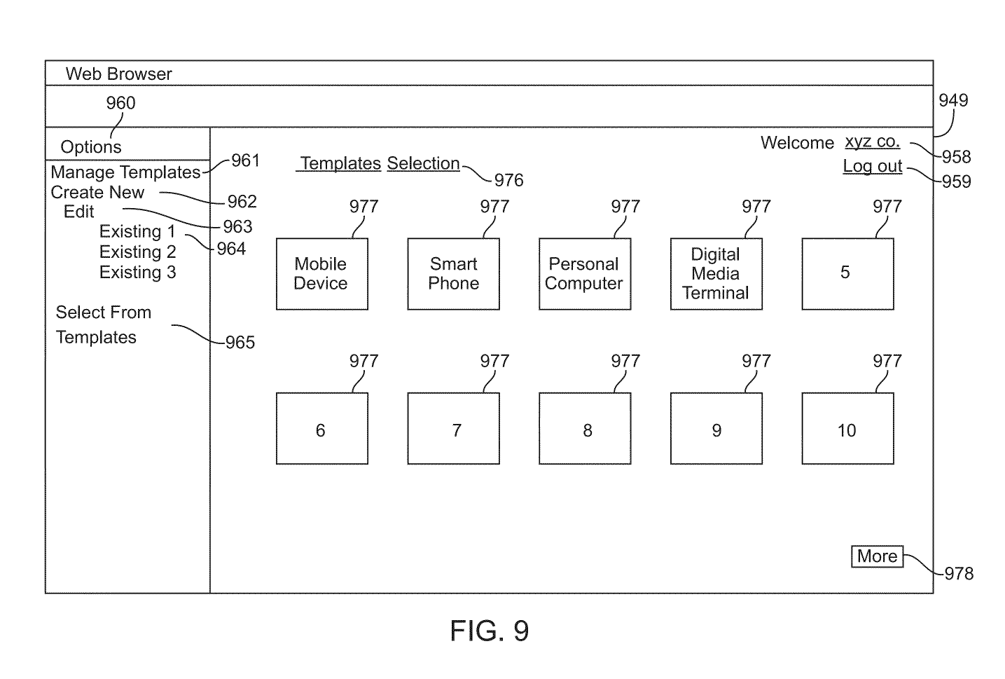

FIG. 9 is an example graphical user interface 949 template selection page 976 for submitting advertisements formatted for use on digital media terminals. An advertiser can navigate to this page by the select from template option 865 from FIG. 8. The graphical user interface can provide advertisers with one or more templates depending on the type of advertisements desired. The options menu 960 can also be present on the template selection page 976. For example, the an Arizona baseball team can view the template selection page 976 and view sample templates 977 for various advertising purposes. The templates can vary in purpose depending on the advertising goal. Advertisements can include but are not limited to, a watermark, a survey, a coupon, a discount, a Facebook™ “like”, a Twitter™ “follow”, of a standard advertisement. An Arizona baseball team can select the template corresponding to coupon, and can put together an offer for discounted future tickets when a user engages a digital media terminal. The template selection page can display a number of template options, and provide a button 978 to enable a user to choose to view more templates.

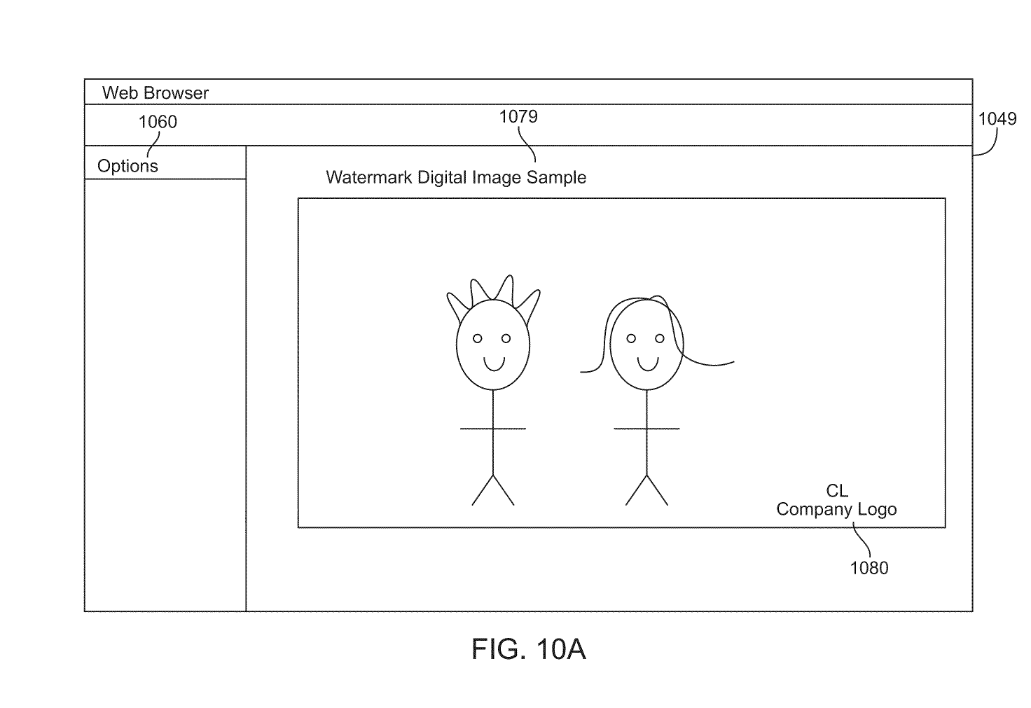

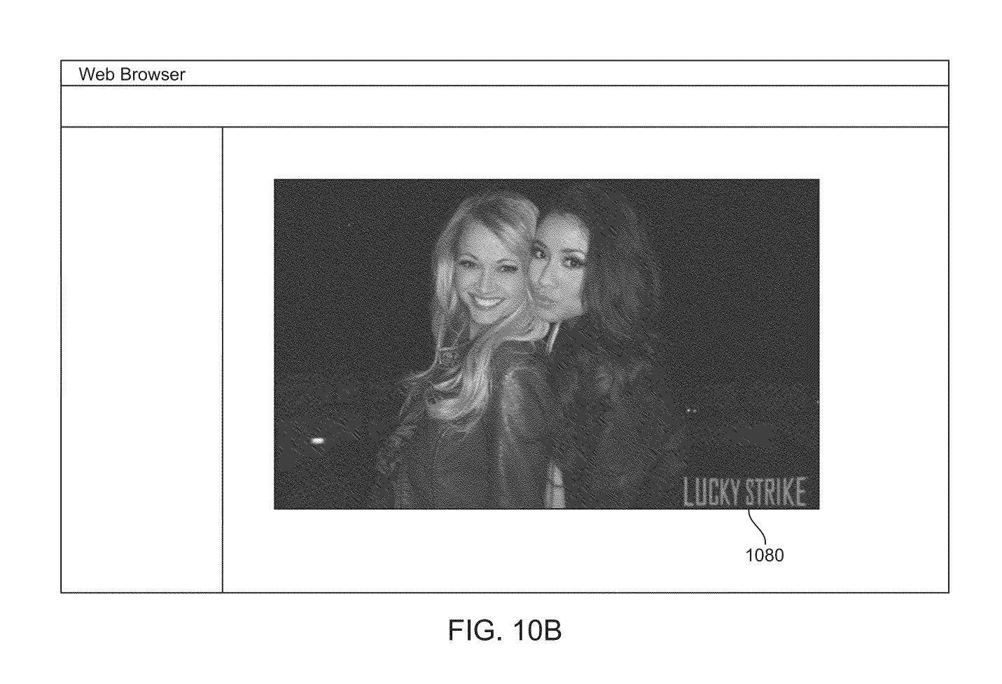

FIGS. 10a and 10b are an example graphical user interface 1049 digital watermark sample and an actual photograph incorporating a watermark 1080. The advertiser can use the graphical user interface 1049 to view their uploaded digital watermark 1080 overlaid onto a sample image. The sample can allow advertisers to adjust their watermark 1080 to ensure the advertisement meets their specifications. The advertiser can navigate to graphical user interface 1049 by selecting current watermark 870 or by selecting an existing advertisement from options menu 863 in FIG. 8. For example, the Arizona baseball team can upload their digital watermark 1080 on the Advertising Main Page 857, and then view the Watermark Digital Image Sample page 1079 to visually see how their digital watermark displays on a sample image. The Arizona baseball team can then adjust the size, color, or location of their digital watermark 1080 to meet their standards. FIG. 10b is an example finished product watermark digital image 1080.

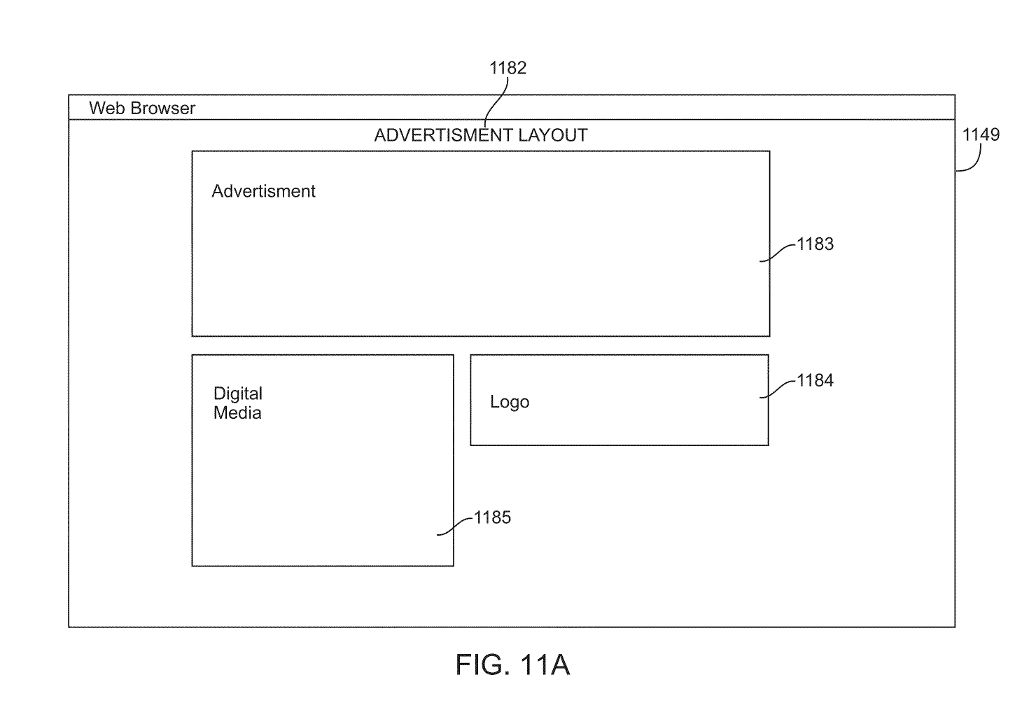

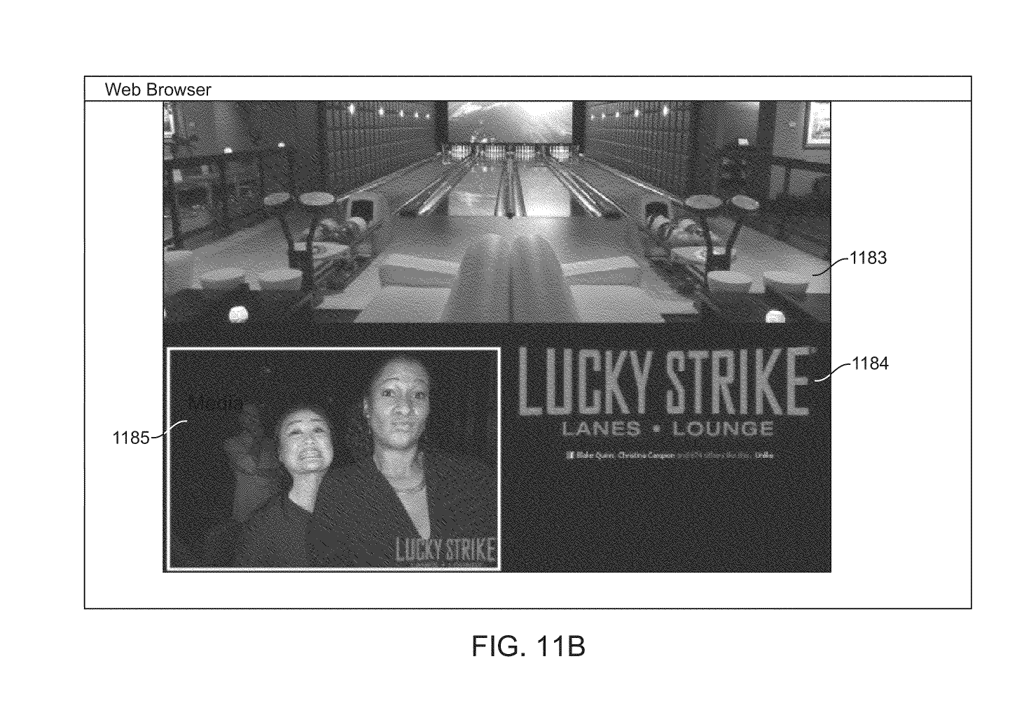

FIGS. 11a and 11b are an example graphical user interface 1149 of an advertisement layout 1182 and a digital media file incorporating an advertisement 1186. The web browser 1150 can display a unique web page featuring the advertiser's advertisement 1183, logo 1184, and the user's digital media file 1185. The advertiser can navigate to advertisement layout 1182 by selecting and existing advertisement from options menu 863, during the process of creating a new advertisement from options menu 861 or by selecting work space 886 from FIG. 8. The advertiser can view this page to visually see the alignment, and display of their prospective advertisement. For example, an Arizona baseball team can use the advertisement layout 1182 to verify the location placement, colors, and overall effectiveness of their advertisement. The baseball team can offer a discount on future concessions in the advertisement 1183, display the team logo 1184, and display the user generated digital media file 1186. FIG. 11b is an example of a finished advertisement layout 1186.

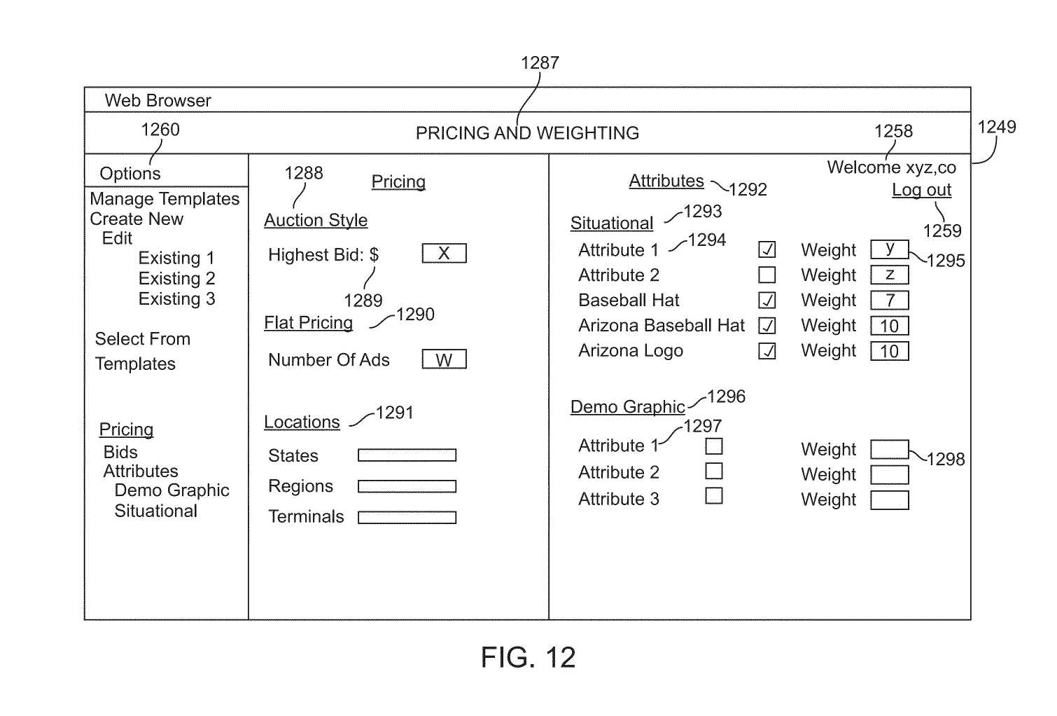

FIG. 12 is an example graphical user interface 1249 of pricing page 1287. The advertiser can use this page to bid on advertising space auction style 1288, buy advertising space 1290, and select locations 1291 of advertisements. The advertiser can also use this page to select situational 1293 and demographic 1296 attributes 1294, 1297 along with weights 1295, 1298 the attributes will hold. The pricing page 1287 can also display the option 1260 menu. For example, an Arizona baseball team can visit the pricing page 1287 to bid on advertisement placement, or choose flat rate pricing. In an advertising bid scenario, the baseball team can select their company logo attribute and set a bid 1289. For example, if the Arizona logo is detected, the team sets their highest bid 1289. If their bid is the highest, their advertisement will be displayed. This option can allow advertisers to target specific demographic attributes. Alternatively, the team can option for specific number of fixed price advertisements 1290, and select specific attributes to be associated with their advertisement. For example, an Arizona baseball team can specific they would like to purchase 100 bids at a price set by the digital media terminal webpage. The prices can vary depending on the amount of advertisements purchased. The team can also select target locations 1291 for their advertisements. The team can select digital media terminals in a specific city, state, collection of cities and states, specific digital media terminals, nationally, internationally or any combination of the aforementioned. It should be known that advertisers can also select a combination of auction style and fixed price advertisements. Additionally, the pricing page 1287 can offer a list of available situational 1293 or demographic 1296 attributes. Attributes can be selected, and weighted 1295, 1298. Attributes can be selected from predefined attributes or they can be created or specified by the advertiser. An advertiser can select any combination of predefined or advertiser created or specified attributes. For example, an Arizona baseball team can select their team logo and weight the selection with a weight of ten. Such a selection would mean that the Arizona baseball team has chosen to place an advertisement whenever its logo appears during a predetermined time. The Arizona baseball team is also enabled to select a baseball hat and weight the selection with a weight of seven. This can enable the team to focus on the team's fans in particular, and also baseball fans in general.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as can be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, CIFS, and AppleTalk™. The network can be, for example, a local area network, a wide-area network, a virtual private network, the Internet, an intranet, an extranet, a public switched telephone network, an infrared network, a wireless network, and any suitable combination thereof.

In embodiments utilizing a Web server, the Web server can run any of a variety of server or mid-tier applications, including HTTP servers, FTP servers, CGI servers, data servers, Java servers, and business application servers. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, or TCL, as well as combinations thereof. The server(s) can also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (“SAN”) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system can also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device.

Embodiments of the present disclosure can be provided as a computer program product including a nontransitory machine-readable storage medium having stored thereon instructions (in compressed or uncompressed form) that can be used to program a computer (or other electronic device) to perform processes or methods described herein. The machine-readable storage medium can include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments can also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software can be via Internet download.

Based on the disclosure and teachings provided herein, it will be understood that other ways and methods of implementing the various embodiments described above are possible. The specification and drawings are illustrative and are not to be construed as limiting the scope of the following claims.

1. A computer-implemented method of distributing a targeted advertisement comprising:
receiving, at a server, a digital image, at least one datum of contact information, and at least one demographic attribute associated with the digital image;
generating a unique network address associated with the digital image;
storing, in a database, the digital image, the a least one datum of contact information, the at least one demographic attribute, and the unique network address;
selecting, based on at least one demographic attribute, an advertisement;
transmitting, via the contact information, the unique network address and the selected advertisement.

2. A method of claim 1, wherein the contact information comprises at least one e-mail address.

3. A method of claim 1, wherein the contact information comprises at least one telephone number.

4. A method of claim 1, wherein the contact information comprises messenger identifier.

5. A method of claim 1, wherein the demographic attribute comprises a gender.

6. A method of claim 1, wherein the demographic attribute comprises an age.

7. A method of claim 1, wherein the demographic attribute comprises an ethnicity.

8. A method of claim 1, wherein the demographic attribute comprises a height.

9. A method of claim 1, wherein the demographic attribute comprises a weight.

10. A method of claim 1, wherein the demographic attribute comprises a hair color.

11. A method of claim 1, wherein the demographic attribute comprises a hair type.

12. A method of claim 1, wherein the demographic attribute comprises number of people present in the digital image.

13. A method of claim 1, wherein the demographic attribute comprises a color.

14. A method of claim 1, wherein the demographic attribute comprises a brand.

15. A method of claim 1, wherein the demographic attribute comprises an environment.

16. A method of claim 1, wherein the demographic attribute comprises the current location.

17. A method of claim 1, wherein the demographic attribute comprises the current weather.
